(19) United States
(12) Patent Application Publication
(10) Pub. No.: US 2002/0031950 A1
(43) Pub. Date: Mar. 14, 2002

(54) Electrically enhanced modular connector for printed wiring board

(75) Inventors: Ray C. Doutrich, Lebanon, PA (US); Stuart C. Stoner, Lewisberry, PA (US); Peter K. Townsend, Camp Hill, PA (US); David F. Fusselman, Middletown, PA (US)

Correspondence Address: Jonathan M. Waldman, Woodcock Washburn Kurtz, Mackiewicz & Norris LLP, One Liberly Place - 16th Floor, Philadelphia, PA, 19103, US

(73) Assignee: BERG Technology, Inc.

(21) Appl. No.: 09/942,486

(22) Filed: Aug. 29, 2001

Related U.S. Application Data
(63) Continuation of application No. 09/358,864, filed on Jul. 22, 1999, now Pat. No. 6,322,393.
Application No. 09/358,864 is a division of application No. 08/417,085, filed on Apr. 4, 1995, now Pat. No. 5,967,844.

(51) Int. Cl. H01R 13/40

(52) U.S. Cl. 439/625

(57) ABSTRACT

An electrical connector for connecting a daughter and a mother printed wiring board. A receptacle is connected to one board on one face and to the header on the other. The header has a conductive housing with opposed end walls and a medial pin receiving wall where it is connected to the other board. The receptacle housing is electrically connected to the header conductive housing by removable springs extending from the end walls of the header housing and separate removable grounding pins extend to a printed wiring board from the medial wall.

### BACKGROUND OF THE INVENTION

1. Field of the Invention:

The present invention relates to electrical connectors and more particularly to modular connectors for use in connecting a daughter printed wiring board to a mother printed wiring board.

2. Brief Description of the Prior Developments:

In the manufacture of computers and other various electronic assemblies, daughter boards are commonly connected to mother boards by means of a connector having a receptacle having a plastic housing and a first and second face wherein terminals are connected in one face to the daughter board and at the other to a header connected to the mother board. Various arrangements have been suggested to ground such connectors to the mother or daughter boards but such arrangements have tended to complicate the construction of the connector. A need, therefore, exists for simple and inexpensive means for grounding connectors between mother and daughter boards. There is also a need for such a connector which reduces crosstalk and EMI.

### SUMMARY OF THE INVENTION

In the electrical connector of the present invention a receptacle is connected to a daughter board. This receptacle has a housing having a first face and a second face and a plurality of terminals extend from the first face of the daughter board to the second face where there is an interface with a shielded header. The header has two end walls and a medial wall and is comprised of a conductive material, preferable a suitable metallic alloy. A plurality of apertures extend through the medial wall and retain signal pins which contact the terminals in the receptacle. There is a first and second face on the medial wall. The first face interfaces with the second face of the receptacle. The second face abuts the printed wiring board. On the second face there are a plurality of recesses into which conductive pins are press fitted to ground the connector. On the inner side of the end walls of the header there are also axial grooves which retain removable springs which contact shields on the receptacle to further aid in grounding the connector.

### BRIEF DESCRIPTION OF THE DRAWINGS

FIG. 1 is a side elevational view of the receptacle element of the connector of the present invention;

FIG. 2 is a side elevational view of the header element of the connector of the present invention;

FIG. 3 is a side elevational view of the engaged receptacle and header elements to form the connector of the present invention;

FIG. 4 is a bottom view of the receptacle element shown in FIG. 1;

FIG. 5 is a front end view of the receptacle shown in FIG. 1;

FIG. 6 is a perspective view of the receptacle shown in FIG. 1;

FIG. 7 is a detailed view of a corresponding area in FIG. 3 with the addition of an affixed printed wiring board in fragment;

FIG. 8 is a top plan view of the header shown in FIG. 2;

FIG. 9 is a front view of the header shown in FIG. 2;

FIG. 10 is a bottom plan view of the header shown in FIG. 2;

FIG. 11 is a rear view of the header shown in FIG. 2;

FIG. 12 is a cross sectional view taken through line XII-XII in FIG. 8;

FIG. 13 is a cross sectional view taken through line XIII-XIII in FIG. 8;

FIG. 14 is a detailed view of the area in circle XIV of FIG. 11;

FIG. 15 is a perspective view of the header shown in FIG. 2.

### DETAILED DESCRIPTION OF THE PREFERRED EMBODIMENT

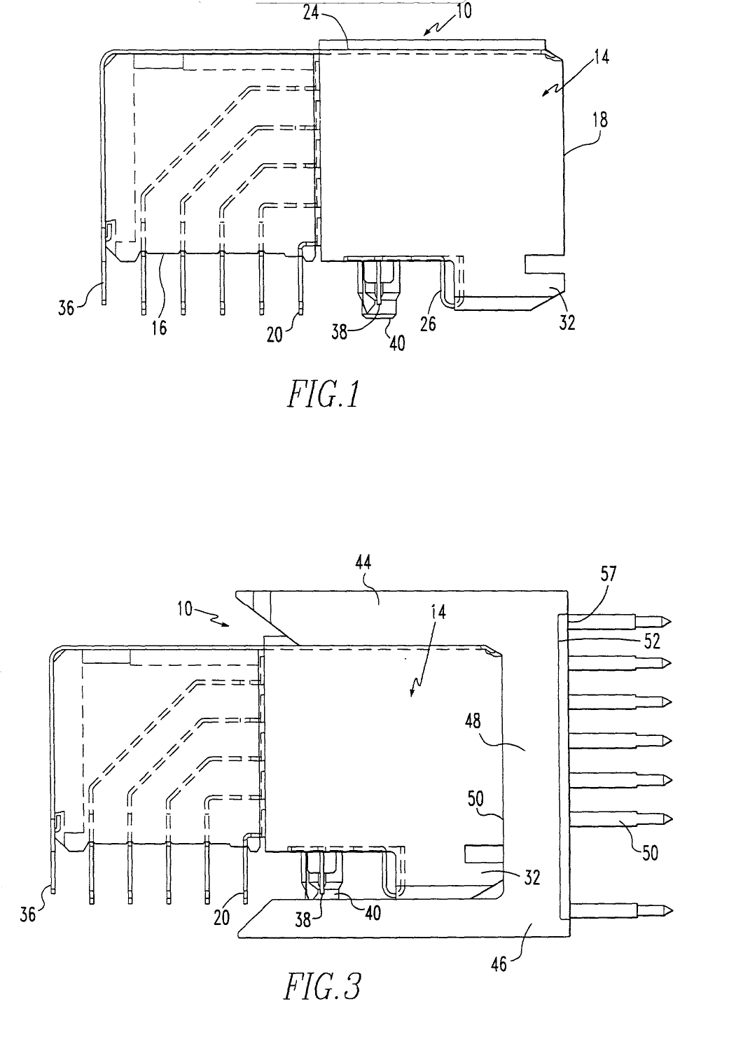

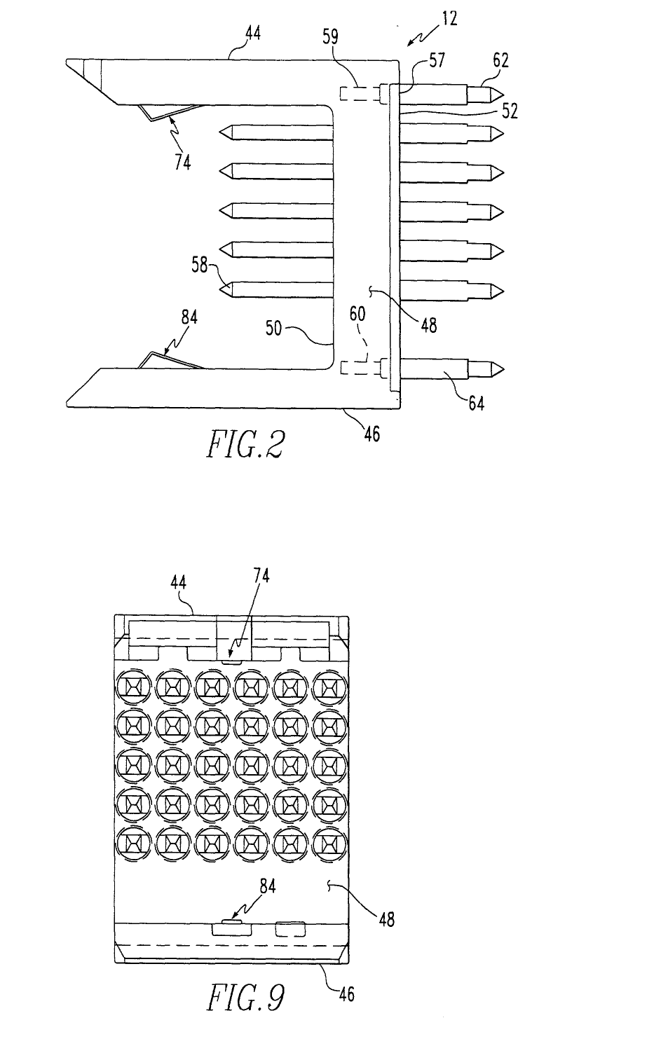

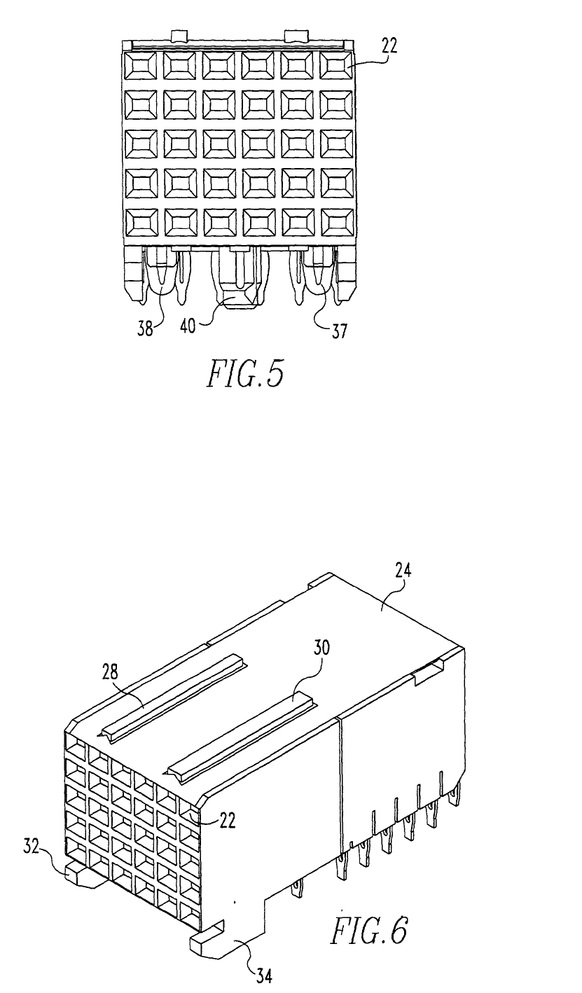

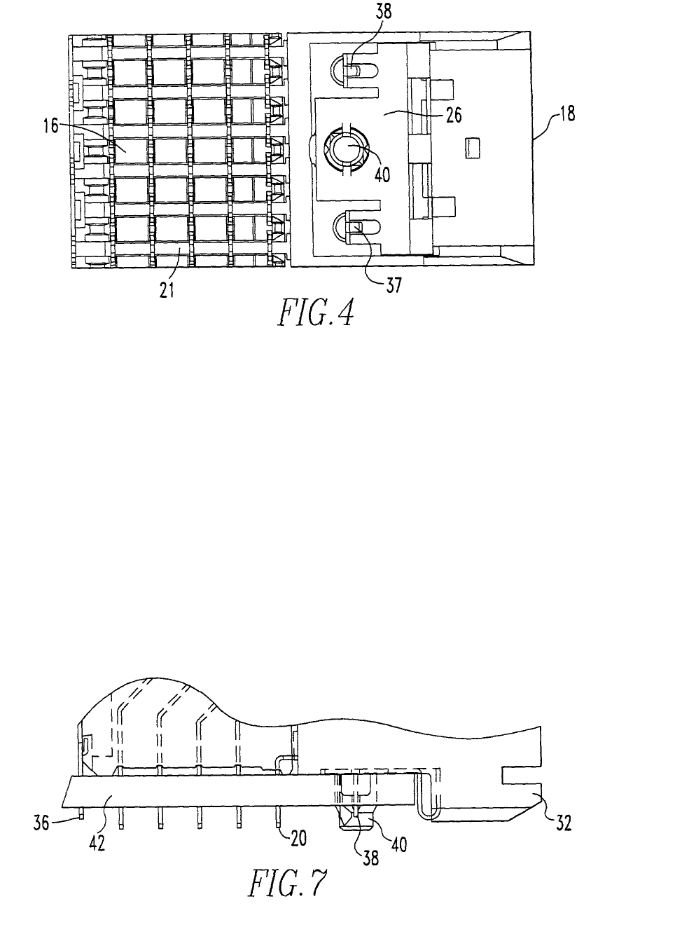

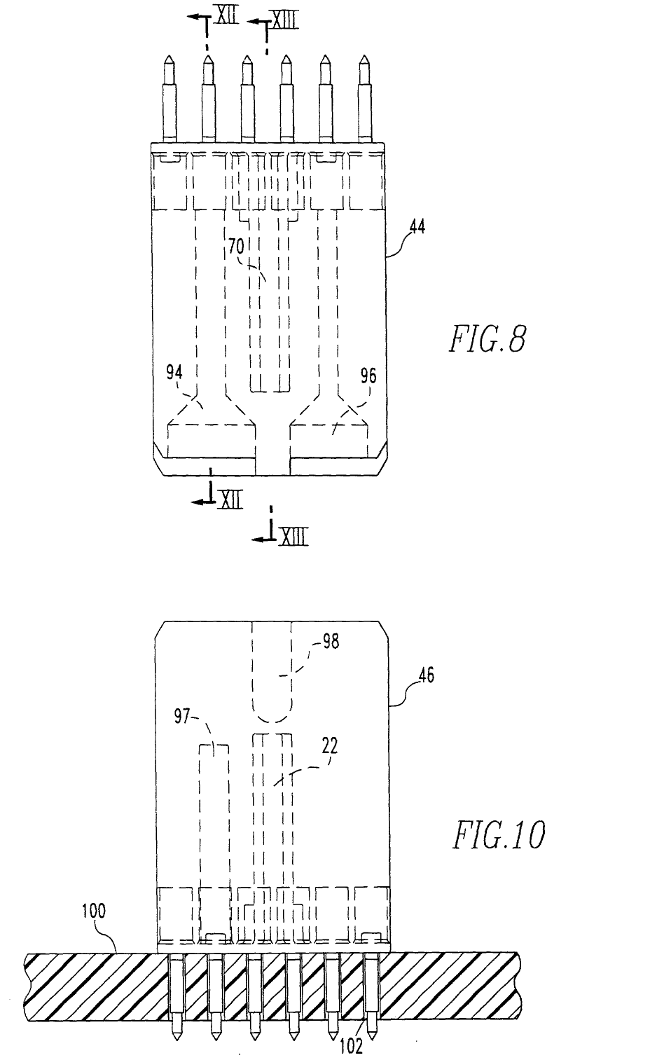

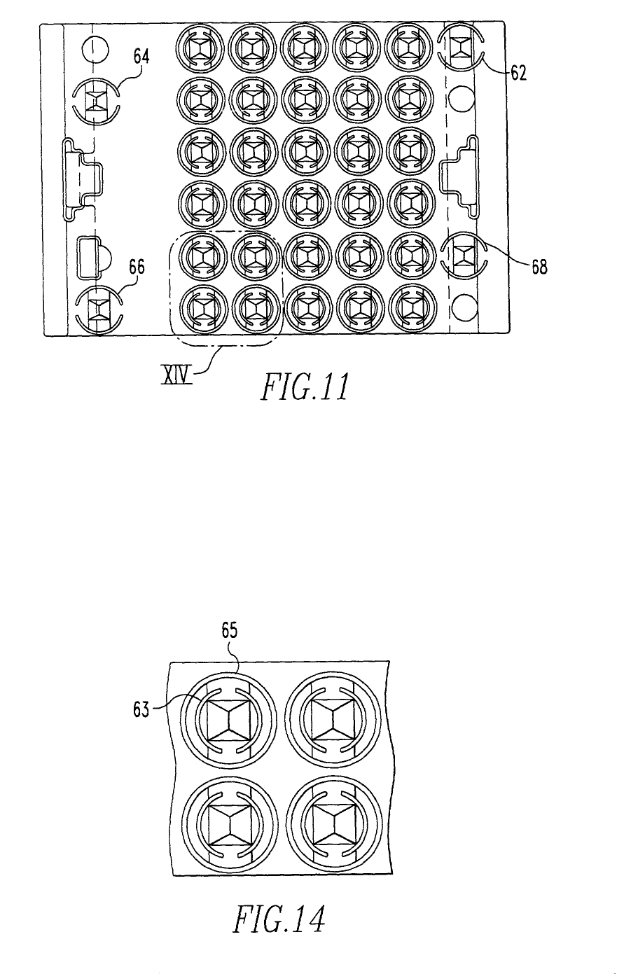

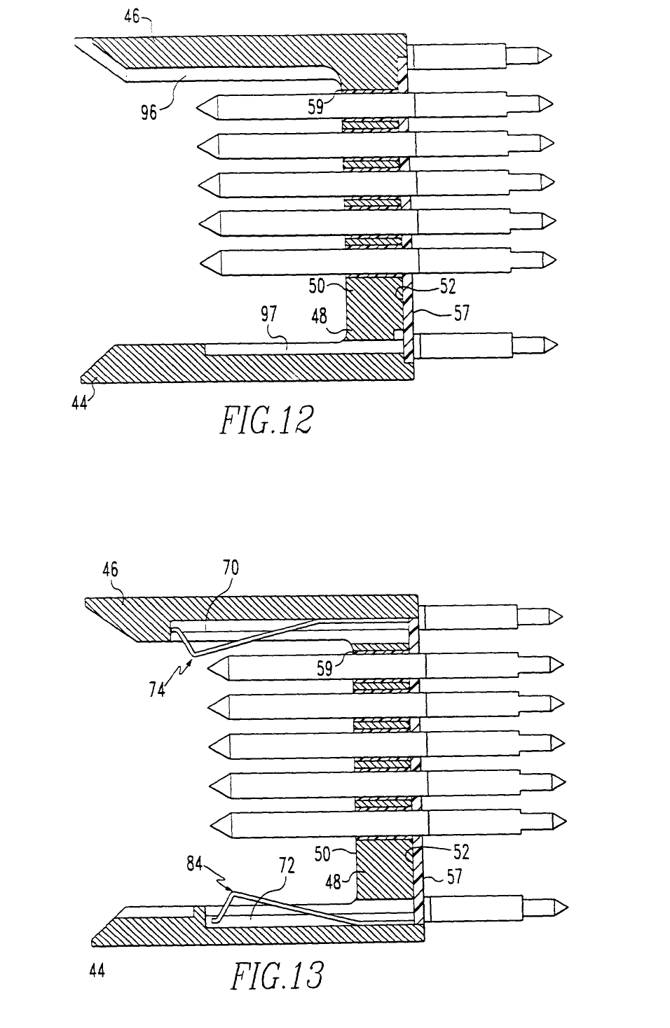

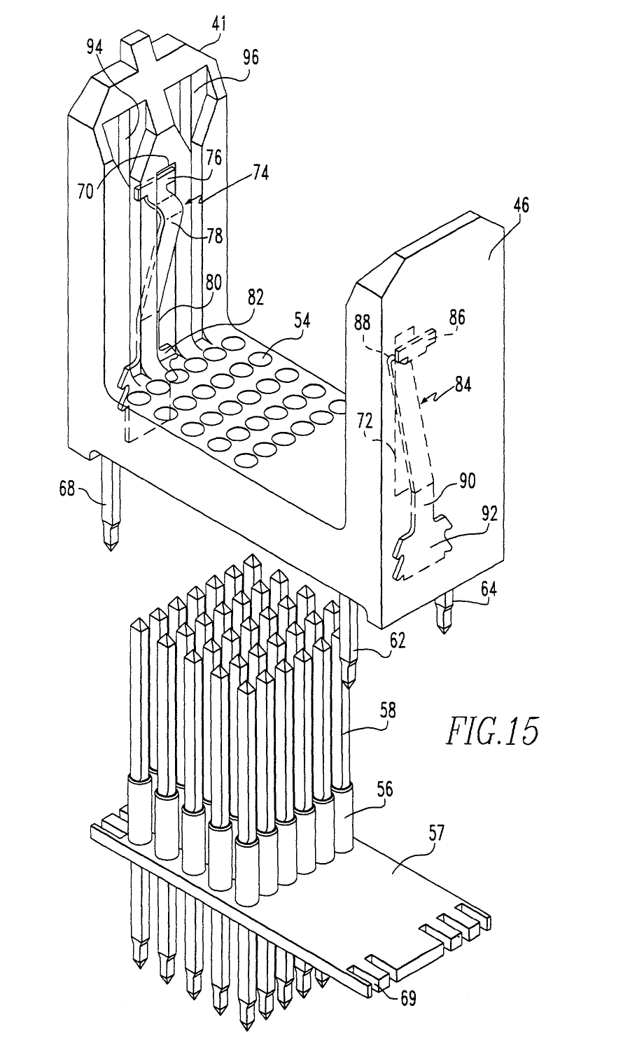

Referring to the figures, the receptacle is shown generally at numeral 10, the shielded header is shown generally at numeral 12. Referring particularly to the FIGS. 1 through 6 the receptacle includes a housing generally at numeral 14 with a first planar face 16, a second planar face 18. Terminals as at 20 extend from the first planar face to the second planar face through passageways as at 21 and then through cavities as at 22. The housing includes top metallic shield 24 and a bottom metallic shield 26. It also includes alignment ribs 28 and 30 and code key holders 32 and 34. Grounding is effected through ground pins 36, 37 and 38 and press peg 40 is used to fix receptacle to a daughter printed wiring board 42 along with the terminals. Referring particularly to FIGS. 2 and 8 through 15, the header includes end walls 44 and 46 and medial wall 48 which is perpendicularly interposed between the end walls. The medial wall includes a first planar face 50 and a second planar face 52. The header 10 can be die cast of a suitable metallic alloy. Passageways as at 54 extend transversely across the medial wall from the first planar face to the second planar face and are equipped with insulative sleeves as at 56 which are integrated with an insulative plate 57. Conductive signal pins as at 58 extend through these passageways to engage the terminals as at 20 positioned in cavities as 22 in the receptacle. On the second planar face of the medial wall there are recesses as at 59 and 60 which extend only partially through this wall and which receive grounding pins as at 62 and 64 by press fit. Other grounding pins 66 and 68 engage other similar recesses in the second planar face of the medial wall. It will be appreciated that additional recesses may be used so that there will be more than one potential position for each grounding pin and so that the grounding pins can be selectively positioned. The grounding pins pass through slots as at 69 in the insulative plate 57. On the inner side of the end walls 44 and 46 there are respectively central vertical grooves 70 and 72. In central vertical groove 70 there is a metallic contact spring 74 which is comprised of a top locking section 76 which engages the side of the groove and is press fit into the groove. A concave section 78 which extends inwardly then back toward the groove, a vertical section 80 and a lower locking section 82 which also engages the groove and which is press fit into the groove. The vertical groove 72 also has a metallic spring 84 which similarly has a top locking section 86, a concave section 88, a vertical section 90 and a lower lock section 92. On each side of the vertical groove 70 there is a lateral vertical groove 94 and 96 which are alignment features that engage ribs 28 and 30 on the receptacle. The spring contacts 74 and 84 are removable from the grooves in which they are mounted and can be optionally used, depending upon the specific characteristics of the receptacle with which they are to be used. The end wall 46 also includes a groove 97 which is useful in the manufacturing of the connector but which has no function thereafter. This end wall also has a recess 98 on its inner side to accommodate the press pin 40. As is particularly shown in FIG. 10, it will be understood that the pins of the header are connected to a mother printed wiring board 100 through apertures as at 102.

The connector as described above is considered to have surprisingly and unexpectantly good crosstalk and EMI reduction characteristics. This connector is also easily and inexpensively grounded to the printed wiring boards to which it is attached.

While the present invention has been described in connection with the preferred embodiments of the various figures, it is to be understood that other similar embodiments may be used or modifications and additions may be made to the described embodiment for performing the same function of the present invention without deviating therefrom. Therefore, the present invention should not be limited to any single embodiment, but rather construed in breadth and scope in accordance with the recitation of the appended claims.

What is claimed is:

1. An electrical connector comprising in combination a receptacle comprising a housing having a first face and a second face and a plurality of conductive means each extending from said first face to said second face and a header having a conductive housing comprising generally parallel end walls with opposed inner faces and a medial wall is interposed between said opposed parallel end walls, said medial wall having a first face and a second face wherein said first face of the medial wall is adjacent to the second face of the receptacle element and a plurality of passages extend between the first and second faces of the medial walls and a plurality of conductive signal pins pass through at least some of said passages and a separate grounding means is attached to the conductive housing of the header.

2. The electrical connector of claim 1 wherein the grounding means is releasably attached to the conductive housing of the header.

3. The electrical connector of claim 2 wherein the grounding means comprises at least one conductive pin.

4. The electrical connector of claim 3 wherein the conductive pin is fixed in a ground pin receiving recess in the conductive housing of the header.

5. The electrical connector of claim 4 wherein the conductive pin is press fit in the ground pin receiving recess.

6. The electrical connector of claim 3 wherein the grounding means comprises a plurality of conductive pins.

7. The electrical connector of claim 4 wherein each of the conductive pins is fixed in a ground pin receiving recess.

8. The electrical connector of claim 7 wherein the conductive pins are press fit in the ground pin receiving recesses.

9. The electrical connector of claim 1 wherein insulative means are positioned between the conductive signal pins and the medial wall of the conductive housing of the header.

10. The electrical connector of claim 9 wherein the ground pin receiving recess is on the medial wall.

11. The electrical connector of claim 10 wherein the ground pin receiving recess is positioned on the second face of the medial wall.

12. The electrical connector of claim 4 wherein there are a plurality of ground pin receiving apertures positioned on the second face of the medial wall.

13. The electrical connector of claim 1 wherein the housing of the receptacle abuts at least one of faces of the end walls of the conductive housing of the header.

14. The electrical connector of claim 13 wherein the housing of the receptacle includes an external metal shielding means.

15. The electrical connector of claim 14 wherein conductive means connect the external metal shielding means of the housing of the receptacle and at least one end wall of the conductive housing of the header.

16. The electrical connector of claim 15 wherein the conductive means connecting the external metal shielding means to at least one of the end walls of the conductive housing of the header are resilient conductive means.

17. The electrical connector of claim 16 wherein a pair of opposed metal springs extend inwardly from both of the opposed inner faces of the end walls of the housing of the header to contact the external metal shielding means of the receptacle.

18. The electrical connector of claim 17 wherein the opposed metal springs are removable from the opposed inner faces of the end walls of the housing of the header.

19. The electrical connector of claim 7 wherein the number of ground pin receiving recesses exceeds the number of ground pins so that the ground pins can be selectively positioned.

20. The electrical connector of claim 1 wherein the conductive signal pins and the grounding means of the header are attached to a printed wiring board.

21. The electrical connector of claim 20 wherein the conductive means of the receptacle is attached to a printed wiring board.

22. An electrical connector comprising in combination a receptacle comprising a housing having a first face and a second face and a plurality of conductive means each extending from said first face to said second face and a header having a conductive housing comprising opposed generally parallel end walls and a medial wall perpendicularly interposed between said opposed parallel end walls and said medial wall having a first face and a second face wherein said first face of the medial wall is adjacent to the second face of the receptacle element and a plurality of passages extend between the first and second faces of the medial walls and a conductive signal pin passes through at least some of said passages and a grounding means extends from the medial wall of the housing and a resilient conductive means extends from at least one of the end walls of the housing of the header to contact the housing of the receptacle.

23. The electrical connector of claim 18 wherein there is an external metal shielding means on the housing of the receptacle and the resilient conductive means extending from the housing of the header contacts said metal shielding means.

24. The electrical connector of claim 19 wherein a pair of opposed springs extend inwardly from both of the end walls of the housing of the header to contact the external medial shielding means of the receptacle.

25. A shielded header having a conductive housing comprising generally parallel end walls and a medial wall is interposed between said opposed parallel end walls, said medial wall having a first face and a second face wherein said first face of the medial wall is adjacent to the second face of the receptacle element and a plurality of passages extend between the first and second faces of the medial walls and a plurality of conductive signal pins pass through at least some of said passages and a separate grounding means is attached to the conductive housing of the header.

26. A shielded header having a conductive housing comprising opposed generally parallel end walls and a medial wall perpendicularly interposed between said opposed parallel end walls and said medial wall having a first face and a second face wherein said first face of the medial wall is adjacent. to the second face of the receptacle element and a plurality of passages extend between the first and second faces of the medial walls and a conductive signal pin passes through at least some of said passages and a grounding means extends from the medial wall of the housing and a resilient conductive means extends from at least one of the end walls of the housing of the header to contact the housing of the receptacle.
